(19) United States
(12) Patent Application Publication
(10) Pub. No.: US 2025/0297573 A1
(43) Pub. Date: Sep. 25, 2025

(54) GAS TURBINE ENGINE

(71) Applicant: General Electric Company, Schenectady, NY (US)

(72) Inventors: Brandon Wayne Miller, Liberty Township, OH (US); Eric Barre, Cincinnati, OH (US); Stephen Gerard Matava, Andover, MA (US); John Carl Glessner, Kings Mills, OH (US); Efren Souza Chavez, Queretaro (MX)

(21) Appl. No.: 18/615,118

(22) Filed: Mar. 25, 2024

(51) Int. Cl. F02C 7/18; F02C 9/18

(52) U.S. Cl. CPC F02C 7/18; F02C 9/18; F05D 2260/213; F05D 2260/232; F05D 2260/606

(57) ABSTRACT

A gas turbine engine comprising: a fan assembly comprising a fan; a turbomachine drivingly coupled to the fan and comprising a compressor section, a combustion section, and a turbine section arranged in serial flow order and defining in part a working gas flowpath, the gas turbine engine defining a bypass passage over the turbomachine, the turbomachine defining an annular cooling passage extending between a CP inlet and a CP outlet, the CP inlet in airflow communication with the working gas flowpath, the bypass passage, or both; an accessory system; a heat exchanger positioned in thermal communication with the annular cooling passage at a location between the CP inlet and the CP outlet, the heat exchanger in thermal communication with the accessory system; and a bleed cooling system defining a BC inlet in airflow communication with the annular cooling passage at a location between the CP inlet and the CP outlet.

### FIELD

The present disclosure relates to a gas turbine engine having a cooling passage and a bleed cooling system.

### BACKGROUND

A gas turbine engine generally includes a turbomachine and a rotor assembly. Gas turbine engines, such as turbofan engines, may be used for aircraft propulsion. In the case of a turbofan engine, the rotor assembly may be configured as a fan assembly, and the fan assembly may be enclosed by an outer nacelle. The outer nacelle may define a bypass passage with the turbomachine.

Generally, improvements to a turbofan engine in the fields of thermal management and aerodynamics would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a schematic view of a portion of a turbomachine in accordance with an exemplary embodiment of the present disclosure.

FIG. 3 is a schematic, cross-sectional view of a cooling passage of the turbomachine of FIG. 2 in accordance with an exemplary embodiment of the present disclosure.

FIG. 4 is a schematic view of a portion of a turbomachine in accordance with another exemplary embodiment of the present disclosure.

FIG. 5 is a schematic view of a hood of the exemplary turbomachine of FIG. 4.

FIG. 6 is a schematic view of a hood of a turbomachine in accordance with an exemplary embodiment of the present disclosure.

FIG. 7 is a schematic view of a portion of a turbomachine in accordance with another exemplary embodiment of the present disclosure.

FIG. 8 is a schematic view of an ejector in accordance with another exemplary embodiment of the present disclosure.

FIG. 9 is a schematic, cross-sectional view of a cooling passage and variable bleed assembly in accordance with an exemplary embodiment of the present disclosure.

FIG. 10 is a schematic view of a portion of a turbomachine in accordance with another exemplary embodiment of the present disclosure.

FIG. 11 is a schematic view of the exemplary turbomachine of FIG. 10 along Line 11-11 in FIG. 10.

FIG. 12 is a schematic view of a portion of a turbomachine in accordance with yet another exemplary embodiment of the present disclosure.

FIG. 12 is a schematic view of a portion of a turbomachine in accordance with still another exemplary embodiment of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” of the engine.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

As used herein, the terms “first”, “second”, and “third” may be used interchangeably to distinguish one component from another and are not intended to signify location or importance of the individual components.

The present disclosure is generally related to a gas turbine engine, such as a turbofan engine.

As design criteria for turbofan engines drives operating conditions to higher pressures and temperatures, it has been recognized that increased cooling capacity would be welcomed in the art. Certain gas turbine engines bleed air from, e.g., a high pressure compressor, and use the bleed air to cool various accessory systems of the turbofan engine. However, such a configuration may result in inefficiencies as the air bled from the high pressure compressor undergoes a relatively high amount of work, and further is generally at an elevated temperature.

Accordingly, in one exemplary aspect, a gas turbine engine is provided having a turbomachine that defines a cooling passage extending between an inlet and an outlet. The inlet is in airflow communication with a working gas flowpath of the turbomachine at a location upstream of a compressor section, a bypass passage of the gas turbine engine at a location outward of the turbomachine, or both. The outlet is in airflow communication with the bypass passage. A heat exchanger is provided in thermal communication with an airflow through the cooling passage. The heat exchanger may be utilized to cool one or more accessory systems of the gas turbine engine.

In such an exemplary aspect, the airflow provided to the heat exchanger may be relatively cool and may be provided from a location upstream of a significant amount of compression (which would result in lost work).

In another exemplary aspect of the present disclosure, a means is provided for urging an airflow through a cooling passage, such as the cooling passage discussed above. In particular, with one exemplary aspect of the present disclosure, a turbomachine of a gas turbine engine is provided, having a variable bleed assembly with a variable bleed duct extending between a variable bleed (VB) inlet and a VB outlet. The VB inlet is in airflow communication with the working gas flowpath at a location downstream of a cooling passage inlet of a cooling passage, and the VB outlet in airflow communication with the cooling passage for urging an airflow through the annular cooling passage. In such a manner, a small amount of high pressure airflow may be utilized to urge a low pressure airflow through the cooling passage. Such may allow for the low pressure airflow to be used for cooling various components of the turbomachine, which may result in an overall more efficient cooling system and gas turbine engine.

In another exemplary aspect, a bleed cooling system of the gas turbine engine extracts airflow from the cooling passage. The bleed cooling system may be, e.g., an under-cowl cooling system, a clearance control system, or combinations thereof, or other systems of the gas turbine engine utilizing cooling air without requiring the cooling air to be highly pressurized. In such an exemplary aspect, the airflow provided to the bleed cooling system of the gas turbine engine may be relatively cool and may be provided from a location upstream of a significant amount of compression (which would result in lost work).

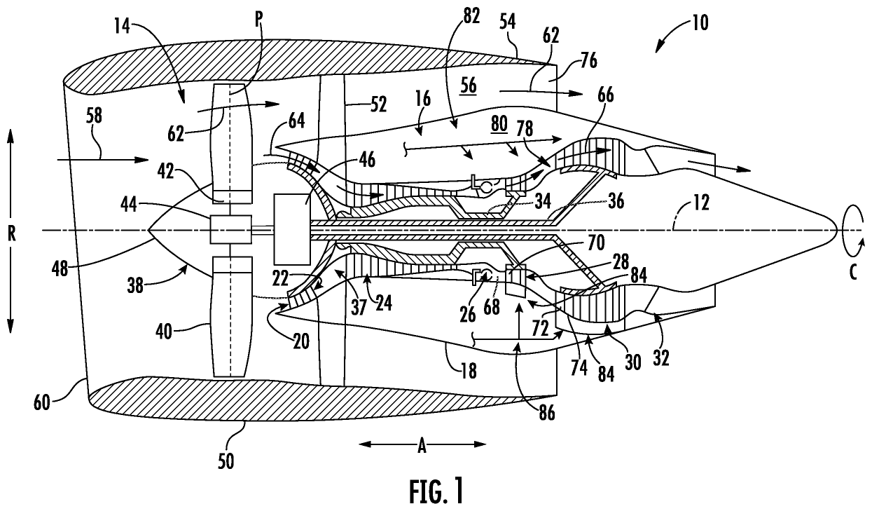

Referring now to the drawings, wherein identical numerals indicate the same elements throughout the figures, FIG. 1 is a schematic cross-sectional view of a gas turbine engine 10 in accordance with an exemplary embodiment of the present disclosure. More particularly, for the embodiment of FIG. 1, the gas turbine engine 10 is a high-bypass turbofan jet engine, sometimes also referred to as a “turbofan engine.” As shown in FIG. 1, the gas turbine engine 10 defines an axial direction A (extending parallel to a longitudinal centerline 12 provided for reference), a radial direction R, and a circumferential direction C extending about the longitudinal centerline 12. In general, the gas turbine engine 10 includes a fan section 14 and a turbomachine 16 disposed downstream from the fan section 14, the turbomachine 16 drivingly coupled to a fan 38 of the fan section 14.

The exemplary turbomachine 16 depicted generally includes a substantially tubular outer casing 18 that defines an annular turbomachine inlet 20. The outer casing 18 encases, in serial flow relationship, a compressor section including a booster or low pressure (LP) compressor 22 and a high pressure (HP) compressor 24; a combustion section 26; a turbine section including a high pressure (HP) turbine 28 and a low pressure (LP) turbine 30; and a jet exhaust nozzle section 32. A high pressure (HP) shaft 34 (which may additionally or alternatively be a spool) drivingly connects the HP turbine 28 to the HP compressor 24. A low pressure (LP) shaft 36 (which may additionally or alternatively be a spool) drivingly connects the LP turbine 30 to the LP compressor 22. The compressor section, combustion section 26, turbine section, and jet exhaust nozzle section 32 together define a working gas flowpath 37. In such a manner, it will be appreciated that the turbomachine inlet 20 is an inlet to the working gas flowpath 37.

In the embodiment shown, the turbomachine inlet 20 is positioned immediately downstream of the fan 38 (i.e., no intervening structure, such as blades, vanes, or struts, therebetween). Further, it will be appreciated that for the embodiment depicted, the LP compressor 22 is located downstream of the fan 38, and there are no intermediate stages of compression between the fan 38 and the LP compressor 22.

For the embodiment depicted, the fan section 14 includes a fan 38 having a plurality of fan blades 40 coupled to a disk 42 in a spaced apart manner. As depicted, the fan 38 is a single stage fan and the fan blades 40 extend outwardly from disk 42 generally along the radial direction R. Each fan blade 40 is rotatable relative to the disk 42 about a pitch axis P by virtue of the fan blades 40 being operatively coupled to a suitable pitch change mechanism 44 configured to collectively vary the pitch of the fan blades 40, e.g., in unison. The gas turbine engine 10 further includes a reduction gearbox 46, and the fan blades 40, disk 42, and pitch change mechanism 44 are together rotatable about the longitudinal centerline 12 by LP shaft 36 across the reduction gearbox 46. The reduction gearbox 46 includes a plurality of gears for adjusting a rotational speed of the fan 38 relative to a rotational speed of the LP shaft 36, such that the fan 38 may rotate at a more efficient fan speed.

Referring still to the exemplary embodiment of FIG. 1, the disk 42 is covered by a rotatable front hub 48 of the fan section 14 (sometimes also referred to as a “spinner”). The front hub 48 is aerodynamically contoured to promote an airflow through the plurality of fan blades 40.

Additionally, the exemplary fan section 14 includes an annular fan casing or outer nacelle 50 that circumferentially surrounds the fan 38 and/or at least a portion of the turbomachine 16. It should be appreciated that the outer nacelle 50 is supported relative to the turbomachine 16 by a plurality of circumferentially-spaced outlet guide vanes 52 in the embodiment depicted. Moreover, a downstream section 54 of the outer nacelle 50 extends over an outer portion of the turbomachine 16 so as to define a bypass passage 56 therebetween. The bypass passage 56 is defined at least partially over the turbomachine 16.

During operation of the gas turbine engine 10, a volume of air 58 enters the gas turbine engine 10 through an associated inlet 60 of the outer nacelle 50 and fan section 14. As the volume of air 58 passes across the fan blades 40, a first portion of air 62 is directed or routed into the bypass passage 56 and a second portion of air 64 as indicated by arrow 64 is directed or routed into the working gas flowpath 37, or more specifically into the LP compressor 22. The ratio between the first portion of air 62 and the second portion of air 64 is commonly known as a bypass ratio. A pressure of the second portion of air 64 is then increased as it is routed through the HP compressor 24 and into the combustion section 26, where it is mixed with fuel and burned to provide combustion gases 66.

The combustion gases 66 are routed through the HP turbine 28 where a portion of thermal and/or kinetic energy from the combustion gases 66 is extracted via sequential stages of HP turbine stator vanes 68 that are coupled to the outer casing 18 and HP turbine rotor blades 70 that are coupled to the HP shaft 34, thus causing the HP shaft 34 to rotate, which supports operation of the HP compressor 24. The combustion gases 66 are then routed through the LP turbine 30 where a second portion of thermal and kinetic energy is extracted from the combustion gases 66 via sequential stages of LP turbine stator vanes 72 that are coupled to the outer casing 18 and LP turbine rotor blades 74 that are coupled to the LP shaft 36, thus causing the LP shaft 36 to rotate, which supports operation of the LP compressor 22 and/or rotation of the fan 38.

The combustion gases 66 are subsequently routed through the jet exhaust nozzle section 32 of the turbomachine 16 to provide propulsive thrust. Simultaneously, the pressure of the first portion of air 62 is substantially increased as the first portion of air 62 is routed through the bypass passage 56 before it is exhausted from a fan nozzle exhaust section 76 of the gas turbine engine 10, also providing propulsive thrust. The HP turbine 28, the LP turbine 30, and the jet exhaust nozzle section 32 at least partially define a hot gas path 78 for routing the combustion gases 66 through the turbomachine 16.

Briefly, it will further be appreciated that the gas turbine engine 10 further includes one or more cooling systems that may require relatively cool airflow during one or more operating conditions.

For example, the gas turbine engine 10, or rather the turbomachine 16 defines one or more under-cowl areas 80 (areas inward of the outer casing 18 along the radial direction R and outward of the working gas flowpath 37 along the radial direction R). The turbomachine 16 depicted includes an undercowl ventilation cooling system 82 for providing relatively cool airflows during operation to maintain components and structures within these under-cowl areas 80 at a desired temperature. In particular, the undercowl ventilation cooling system 82 may provide the relatively cool air to the under-cowl areas 80 outward along the radial direction R of (and aligned along the axial direction A with) the combustion section 26, HP turbine 28, LP turbine 30, exhaust 32, or combinations thereof.

The one or more cooling systems further includes a clearance control system 84. The clearance control system 84 is essentially a thermal management system for outer shrouds to control thermal growth during certain operating conditions to control a clearance between the outer shrouds and rotating rotor blades inward thereof (along the radial direction R). For example, the clearance control system 84 depicted includes a shroud cooling assembly thermally coupled to one or more shrouds or other structures outward of the respective turbines to provide such functionality. The clearance control system 84 (and shroud cooling assembly) may more specifically receive a relatively cool airflow 86 during one or more operations to perform such functionality.

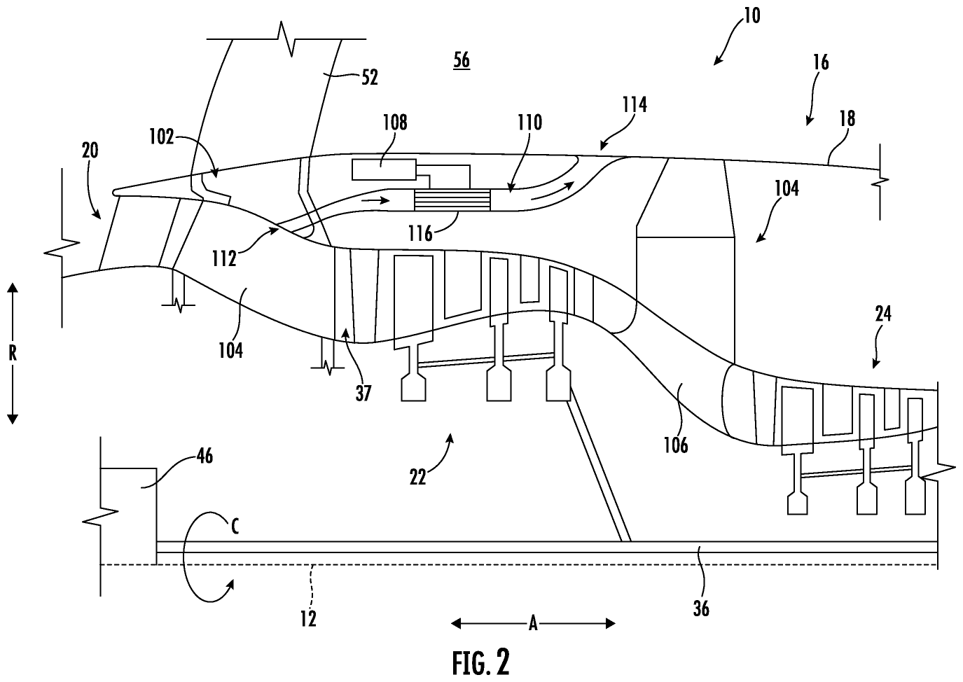

The gas turbine engine 10 may additionally or alternatively include other cooling systems. Notably, for the embodiment depicted, the cooling systems noted (the undercowl ventilation cooling system 82 and the clearance control system 84) may not require the relatively cool airflows to be at a high pressure in order to function as intended. Accordingly, bleed airflow from an annular duct as described herein below (see, e.g., FIGS. 2, et seq.) may provide the desired relatively cool airflow for these cooling systems.

It should be appreciated, however, that the exemplary gas turbine engine 10 depicted in FIG. 1 is by way of example only, and that in other exemplary embodiments, the gas turbine engine 10 may have any other suitable configuration. For example, although the gas turbine engine 10 depicted is configured as a ducted gas turbine engine (i.e., including the outer nacelle 50), in other embodiments, the gas turbine engine 10 may be an unducted gas turbine engine (such that the fan 38 is an unducted fan, and the outlet guide vanes 52 are cantilevered from the outer casing 18). Additionally, or alternatively, although the gas turbine engine 10 depicted is configured as a geared gas turbine engine (i.e., including the reduction gearbox 46) and a variable pitch gas turbine engine (i.e., including a fan 38 configured as a variable pitch fan), in other embodiments, the gas turbine engine 10 may additionally or alternatively be configured as a direct drive gas turbine engine (such that the LP shaft 36 rotates at the same speed as the fan 38), as a fixed pitch gas turbine engine (such that the fan 38 includes fan blades 40 that are not rotatable about a pitch axis P), or both. It should also be appreciated that, in still other exemplary embodiments, aspects of the present disclosure may be incorporated into any other suitable gas turbine engine. For example, in other exemplary embodiments, aspects of the present disclosure may (as appropriate) be incorporated into, e.g., a turboprop gas turbine engine.

Referring now to FIG. 2, a close-up, schematic view is depicted of a portion of the exemplary gas turbine engine 10 of FIG. 1. In particular, the view of FIG. 2 is a close-up of the turbomachine 16 of FIG. 1, depicting the turbomachine inlet 20, the compressor section including the LP compressor 22 and the HP compressor 24, the LP shaft 36, and the reduction gearbox 46. Further, the outer casing 18 of the turbomachine 16 is depicted extending around at least a portion of the compressor section, with the bypass passage 56 defined in part thereby.

As will be appreciated from the view of FIG. 2, the turbomachine 16 further includes a compressor forward frame 100 and a compressor mid-frame 102. The compressor forward frame 100 includes a strut 104 extending through the working gas flowpath 37 at a location upstream of the LP compressor 22 and downstream of the turbomachine inlet 20. Similarly, the compressor mid-frame 102 includes a strut 106 extending through the working gas flowpath 37 at a location downstream of the LP compressor 22 and upstream of the HP compressor 24. The compressor forward frame 100 and the compressor mid-frame 102 may provide structural support to various components of the gas turbine engine 10.

As will be appreciated, the exemplary gas turbine engine 10 depicted includes one or more accessory systems 108 for facilitating operations of the gas turbine engine 10. The one or more accessory systems 108 may include one or more of an oil lubrication system, a fuel delivery system, a cooled cooling air (CCA) system, an engine controller cooling system, etc. A single accessory system 108 is depicted schematically in FIG. 2 by way of example.

Moreover, in order to assist with cooling the one or more accessory systems 108, such as the accessory system 108 depicted, the turbomachine 16 further defines a cooling passage 110 extending between a cooling passage (CP) inlet 112 and a CP outlet 114. As will be appreciated from the description herein, the cooling passage 110 is an annular cooling passage.

The CP inlet 112 is in airflow communication with the working gas flowpath 37 at a location upstream of the compressor section of the turbomachine 16, the bypass passage 56, or both. More specifically, for the embodiment depicted, the CP inlet 112 is in airflow communication with the working gas flowpath 37 at a location upstream of the LP compressor 22 and downstream of the turbomachine inlet 20. More specifically, still, for the embodiment shown, the CP inlet 112 is aligned with the compressor forward frame 100 along the axial direction A of the gas turbine engine 10. In such a manner, the CP inlet 112 is configured to receive an airflow from the working gas flowpath 37 that is been compressed by the fan 38 of the fan section 14 (see FIG. 1). For example, a pressure of an airflow received through the CP inlet 112 and provided to the cooling passage 110 may be substantially equal (e.g., within 10% of) to a pressure of the airflow provided through the turbomachine inlet 20.

Referring still to FIG. 2, the CP outlet 114 is in airflow communication with the bypass passage 56. In particular, for the embodiment shown, the CP outlet 114 is in airflow communication with the bypass passage 56 at a location aft of the CP inlet 112 and forward of the compressor mid-frame 102. In particular, for the embodiment shown, the CP outlet 114 is aligned with the compressor section along the axial direction A.

Further, the turbomachine 16 includes a heat exchanger 116 that is in thermal communication with the airflow through the cooling passage 110. In particular, the heat exchanger 116 is positioned within the cooling passage 110 or defines a portion of the cooling passage 110. In such a manner, the heat exchanger 116 may be configured to transfer heat from a fluid to the airflow through the cooling passage 110.

In particular, for the embodiment shown the heat exchanger 116 is further in thermal communication with the accessory system 108 of the gas turbine engine 10 for transferring heat from the accessory system 108 to the airflow through the cooling passage 110. In such a manner the cooling passage 110 may provide cooling for the accessory system 108.

It will be appreciated that for the embodiment shown, although a single heat exchanger 116 and a single accessory system 108 are depicted, in other exemplary embodiments, other suitable configurations may be provided.

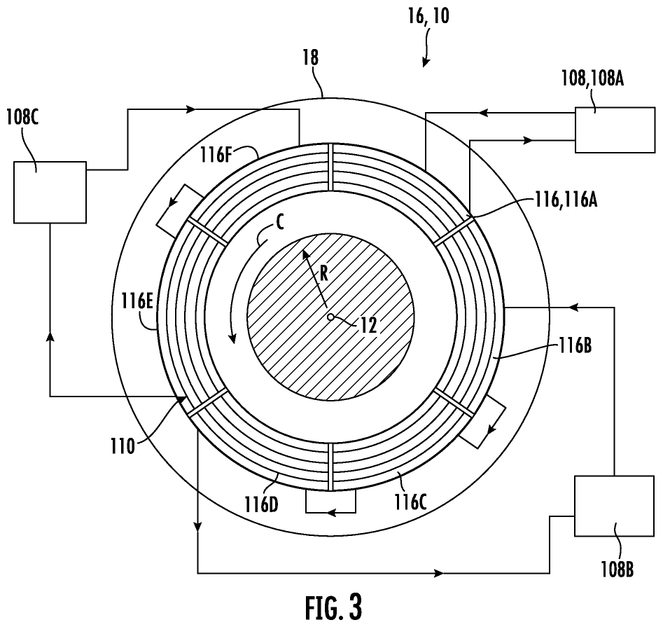

For example, referring now briefly to FIG. 3, a schematic, cross-sectional view of a turbomachine 16 including a cooling passage 110 in accordance with an exemplary aspect of the present disclosure is provided. The exemplary cooling passage 110 and heat exchanger 116 of FIG. 3 may be configured in a similar manner as exemplary cooling passage 110 and heat exchanger 116 described above with reference to FIG. 2.

However, for the embodiment shown, the heat exchanger 116 is a first heat exchanger 116A of a plurality of heat exchangers 116 arranged along a circumferential direction C of the gas turbine engine 10. The plurality of heat exchangers 116 are each positioned within the cooling passage 110.

Notably, for the embodiment shown, the accessory system 108 is also a first accessory system 108A of a plurality of accessory systems 108. Each of the plurality of accessory systems 108 utilizes one or more of the plurality of heat exchangers 116. For example, the first accessory system 108A is in thermal communication with the first heat exchanger 116A. A second accessory system 108B of the plurality of accessory systems 108 is in thermal communication with a second heat exchanger 116B, a third heat exchanger 116C, and a fourth heat exchanger 116D. Notably, the second heat exchanger 116B, the third heat exchanger 116C, and the fourth heat exchanger 116D are arranged in serial flow order. Further, a third accessory system 108C of the plurality of accessory systems 108 is in thermal communication with a fifth heat exchanger 116E and a sixth heat exchanger 116F.

In such a manner, it will be appreciated that an airflow through the cooling passage 110 may be utilized as a heat sink for a variety of accessory systems 108 of the gas turbine engine 10.

Moreover, it will be appreciated that in other exemplary embodiments, other suitable structures may be provided to assist with generating an airflow through the cooling passage 110 of the present disclosure.

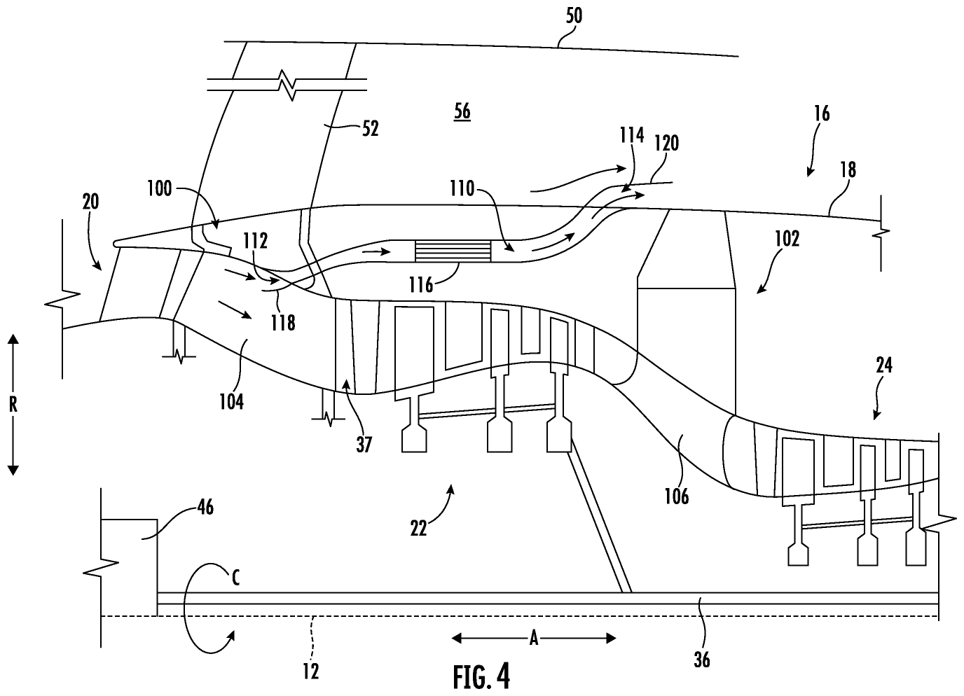

For example, referring now to FIG. 4, a close-up, schematic view of a gas turbine engine 10 in accordance with another exemplary aspect of the present disclosure is provided. The exemplary gas turbine engine 10 depicted in FIG. 4 may be configured in a similar manner as the exemplary gas turbine engine 10 described above with reference to FIGS. 1 and 2. The same or similar numbers may refer to the same or similar part.

For example, the exemplary gas turbine engine 10 depicted in FIG. 4 generally includes a turbomachine 16 defining a cooling passage 110 extending between a CP inlet 112 and a CP outlet 114. The CP inlet 112 is in airflow communication with a working gas flowpath 37 of the turbomachine 16 at a location upstream of a compressor section of the turbomachine 16. The CP outlet 114 is in airflow communication with a bypass passage 56 of the gas turbine engine 10 defined between an outer nacelle 50 and the turbomachine 16.

Notably, as with the embodiment above, the CP inlet 112 is configured to receive an airflow compressed by a fan 38 of the gas turbine engine 10 (see FIG. 1), but is positioned upstream of any additional stages of compression. Accordingly, in order to assist with generating an airflow through the cooling passage 110, the turbomachine 16 includes a means for urging the airflow through the cooling passage 110.

More specifically, for the embodiment depicted, the means includes an inlet scoop 118 extending into the working gas flowpath 37 at the CP inlet 112 to divert a portion of an airflow through the working gas flowpath 37 through the CP inlet 112 of the cooling passage 110. In the embodiment depicted, the inlet scoop 118 is an annular scoop extending 360° about a longitudinal centerline 12 of the gas turbine engine 10. Further, for the embodiment depicted, the inlet scoop 118 is a fixed structure.

However, it will be appreciated that in other exemplary embodiments, the inlet scoop 118 may instead be configured in any other suitable manner (e.g., may be configured as a plurality of individual inlet scoops 118 arranged along a circumferential direction C of the gas turbine engine 10, may be a variable scoop capable of being deployed and retracted, etc.).

Further, for the embodiment depicted, the means for urging the airflow through the cooling passage 110 additionally includes a hood 120 extending over the CP outlet 114 of the cooling passage 110. The hood 120 extends into the bypass passage 56, such that a cross-sectional area of the bypass passage 56 at the hood 120 is less than a cross-sectional area of the bypass passage 56 immediately upstream of the hood 120. In such a manner, the hood 120 may form a nozzle to increase a speed of an airflow through the bypass passage 56, reducing a static pressure at the CP outlet 114 of the cooling passage 110. As such, the hood 120 may generate a delta pressure to urge the airflow through the cooling passage 110.

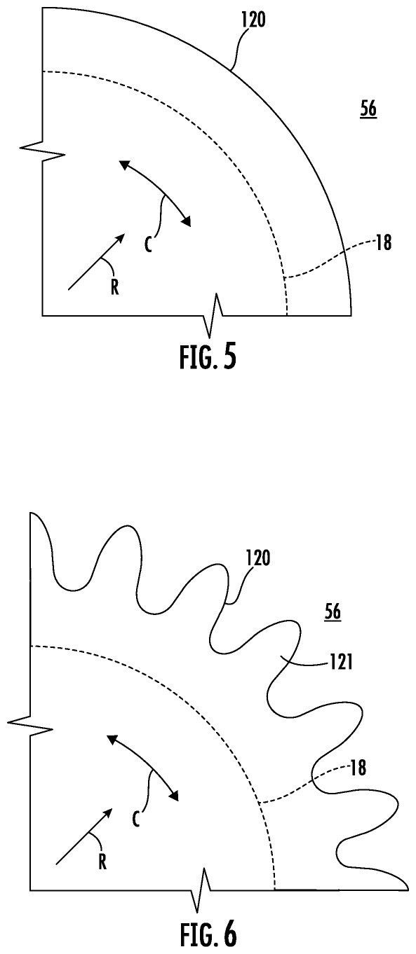

Briefly, referring to FIG. 5, a partial, schematic, cross-sectional view of the hood 120 is depicted, as viewed along the axial direction A. As shown, for the embodiment depicted, the hood 120 is a relatively smooth hood 120.

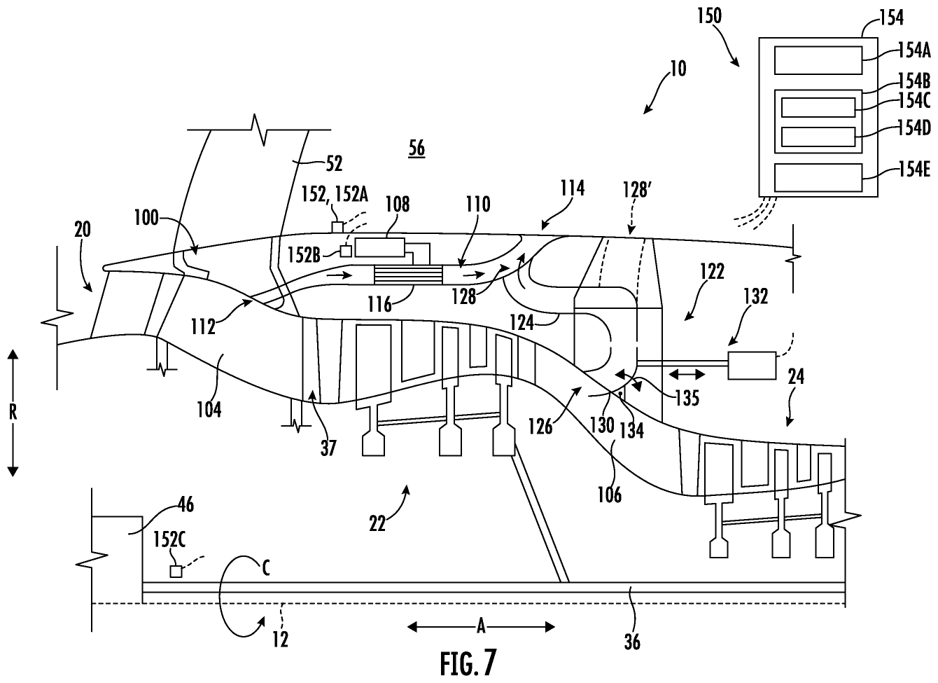

Alternatively, referring briefly to FIG. 6, partial, schematic, cross-sectional view of a hood 120 in accordance with another exemplary embodiment of the present disclosure, as may be incorporated into the gas turbine engine 10 of FIG. 4 is depicted. For the embodiment of FIG. 6, the hood 120 is configured as a mixer having a plurality of lobes 121 spaced along a circumferential direction C having sequential peaks and valleys, such that a radial height of the hood 120 (and lobes 121) defines a sinusoidal pattern along the circumferential direction C. The plurality of lobes 121 may raise the radial height of the hood 120 locally along the circumferential direction C and therefore maximally reduce an exit static pressure at the CP outlet 114 at such local position by increasing the fan airflow Mach number at the local position over the lobe 121 of the hood 120.

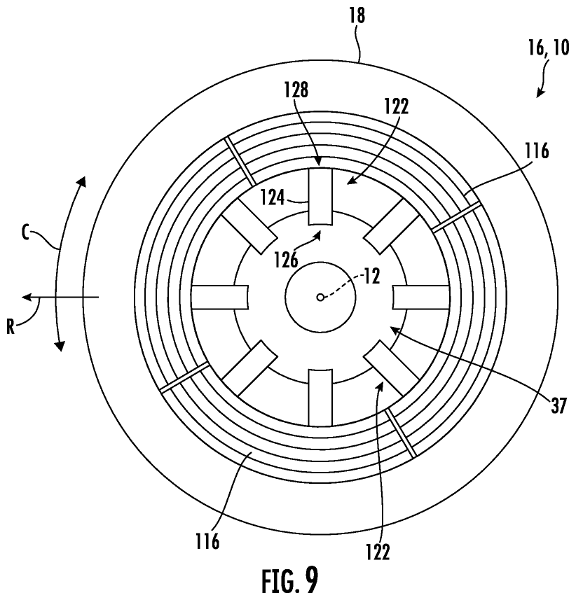

Further, still, in other exemplary embodiments, the means for urging the airflow through the cooling passage 110 may be any other suitable means, such as a pump or compressor, or an ejector in airflow communication with a high-pressure air source. For example, in certain exemplary embodiments, the means may include an ejector in airflow communication with a variable bleed assembly, and further in airflow communication with the cooling passage 110 (see, e.g., FIG. 8 below). Alternatively, in other embodiments, the high pressure air source may be any other suitably high pressure air source, such as an LP compressor bleed, an HP compressor bleed, a turbine exhaust bleed, or a combination thereof. In certain embodiments, the ejector may be positioned downstream of the heat exchanger 116 (as shown in FIG. 8). Alternatively, in other embodiments, the ejector may be positioned upstream of the heat exchanger 116 (FIGS. 2 and 4).

Referring again to FIGS. 2 and 4, in one or more of the above exemplary embodiments, it will be appreciated that the cooling passage 110 may be configured to receive sufficient air flow therethrough to provide a desired amount of cooling to the one or accessory systems 108 of the gas turbine engine 10. For example, in certain exemplary embodiments, it will be appreciated that during operation of the gas turbine engine 10 at a first operating condition, the cooling passage 110 may be configured to receive between 2% and 20% of the total airflow through the working gas flowpath 37 at a location upstream of the CP inlet 112 and downstream of the turbomachine inlet 20. For example, in certain exemplary embodiments, the cooling passage 110 may be configured to receive between 4% and 12% of the total airflow through the working gas flowpath 37 at the location upstream of the CP inlet 112 and downstream of the turbomachine inlet 20. In certain exemplary aspects, the first operating condition may be a high power operating condition (e.g., a takeoff operating condition), wherein a relatively high amount of cooling may be desirable for the gas turbine engine 10.

It will be appreciated that including a turbomachine defining a cooling passage in accordance with one or more exemplary aspects of the present disclosure may allow for a relatively cool airflow to be utilized for cooling one or accessory systems of the gas turbine engine prior to such airflow being subjected to additional stages of compression. In such a manner, the cooling passage may provide for a relatively efficient way to cool the various accessory systems, as the airflow is utilized prior to work in the form of compression having been applied thereto. Further, by transferring heat to such airflow prior to such airflow being provided to the bypass passage, additional energy may be transferred to the bypass passage, which may increase an overall propulsive efficiency of the gas turbine engine.

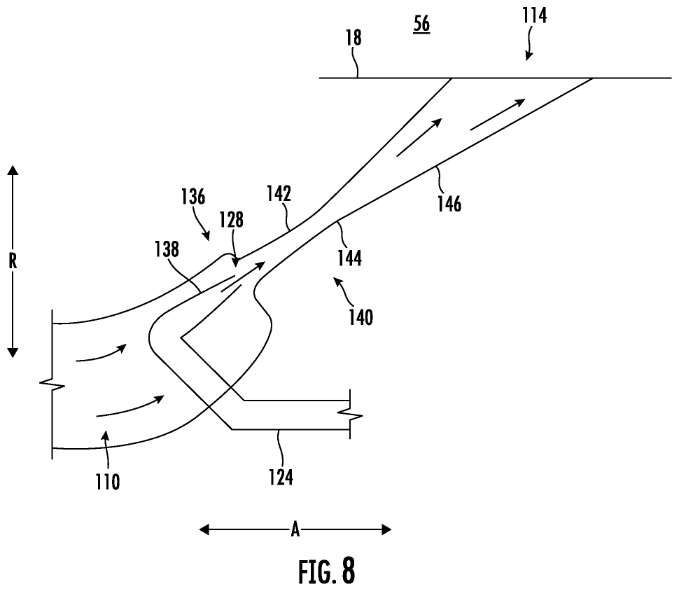

Referring now to FIG. 7, a close-up, schematic view of a gas turbine engine 10 in accordance with yet another exemplary aspect of the present disclosure is provided. The exemplary gas turbine engine 10 depicted in FIG. 7 may be configured in a similar manner as exemplary gas turbine engine 10 described above with reference to FIGS. 1 and 2. The same or similar numbers may refer to the same or similar part.

For example, the exemplary gas turbine engine 10 depicted in FIG. 7 generally includes a turbomachine 16 defining a cooling passage 110 extending between a CP inlet 112 and a CP outlet 114. The CP inlet 112 is in airflow communication with a working gas flowpath 37 of the turbomachine 16 at a location upstream of a compressor section of the turbomachine 16. The CP outlet 114 is in airflow communication with a bypass passage 56 of the gas turbine engine 10 defined between an outer nacelle 50 (not shown; see FIG. 1) and the turbomachine 16.

Notably, as with the embodiment above, the CP inlet 112 is configured to receive an airflow compressed by a fan 38 of the gas turbine engine 10 (see FIG. 1), but is positioned upstream of any additional stages of compression. Accordingly, in order to assist with generating an airflow through the cooling passage 110, the turbomachine 16 includes a means for urging the airflow through the cooling passage 110.

More specifically, for the embodiment of FIG. 7, the gas turbine engine 10 further includes a variable bleed assembly 122. The variable bleed assembly 122 includes a variable bleed duct 124 extending between a VB inlet 126 and a VB outlet 128.

The VB inlet 126 is in airflow communication with the working gas flowpath 37 at a location downstream the CP inlet 112. In particular, for the embodiment depicted, the CP inlet 112 is in airflow communication with the working gas flowpath 37 at a location upstream of a compressor of the compressor section, and more specifically, of an LP compressor 22 of the compressor section, and the VB inlet 126 is in airflow communication with the working gas flowpath 37 at a location downstream of the LP compressor 22. More specifically, still, for the embodiment shown, the VB inlet 126 is in airflow communication with the working gas flowpath 37 at a location upstream of an HP compressor 24 and aligned with a compressor mid-frame 102 of the turbomachine 16 along an axial direction A of the gas turbine engine 10.

Referring still to FIG. 7, the VB outlet 128 is in airflow communication with the cooling passage 110. More specifically, for the embodiment depicted the VB outlet 128 is in airflow communication with the cooling passage 110 at a location downstream of a heat exchanger 116 (the heat exchanger 116 being in thermal communication with an airflow through the cooling passage 110).

As will be appreciated from the exemplary embodiment depicted in FIG. 7, in the embodiment depicted, substantially all of an airflow through the variable bleed duct 124 (i.e., at least 90% of the airflow through the variable bleed duct 124) is provided through the VB outlet 128 to the cooling passage 110.

It will be appreciated, however, that in other embodiments, it may not be necessary to provide substantially all of the airflow through the variable bleed duct 124 to the cooling passage 110 through the VB outlet 128. In such a manner, the VB outlet 128 may be a first VB outlet, and the variable bleed duct 124 may further include a second VB outlet 128′. The second VB outlet 128′, as is depicted in phantom may be in direct airflow communication with the bypass passage 56 (i.e., may provide the airflow from the variable bleed duct 124 to the bypass passage 56 without merging or mixing with any other airflow upstream of the bypass passage 56). In the embodiment depicted, the variable bleed duct 124 splits to extend to both the first VB outlet 128 and the second VB outlet 128′.

As will be appreciated, providing the airflow through the variable bleed duct 124 to the cooling passage 110 through the VB outlet 128 may urge the airflow through the cooling passage 110. In such a manner, the variable bleed assembly 122 may be a means for urging the airflow through the cooling passage 110.

In order to modulate the amount of airflow through the cooling passage 110, the variable bleed assembly 122 may be capable of varying an amount of airflow provided therethrough to the cooling passage 110. In particular, for the embodiment of FIG. 7, the variable bleed assembly 122 includes a variable bleed valve 130 for varying the amount of airflow through the variable bleed duct 124. In the embodiment depicted, the variable bleed valve 130 is located at an upstream end of the variable bleed duct 124 and includes the VB inlet 126.

More specifically, for the embodiment depicted the variable bleed assembly 122 further includes an actuator 132 coupled to the variable bleed valve 130 configured to actuate the variable bleed valve 130 about a pin 134, to pivot the variable bleed valve 130 between a deployed position (shown) and a stowed position (not shown), and optionally various positions therebetween, as is illustrated by arrow 135. The variable bleed valve 130 may be moved from the deployed position to the stowed position by rotating in a clockwise direction about the pin 134 in the view depicted, such that the VB inlet 126 is no longer exposed to the working gas flowpath 37.

The variable bleed valve 130 may be moved between the fully deployed position (shown) whereby the variable bleed duct 124 extracts a maximum amount of airflow from the working gas flowpath 37, the fully stowed position whereby the variable bleed valve 130 extracts substantially no airflow from the working gas flowpath 37 (i.e., less than 5% of the maximum amount of airflow extracted), and any suitable position therebetween (one or more partially deployed positions).

The airflow from the variable bleed duct 124 may be provided to the cooling passage 110 from the VB outlet 128 in any suitable manner. For example, referring briefly to FIG. 8, it will be appreciated that in certain exemplary embodiments, the VB outlet 128 forms at least in part an ejector 136 with the cooling passage 110. In particular, for the embodiment of FIG. 8, the VB outlet 128 includes a fluid nozzle 138 configured to provide a relatively high pressure fluid flow. Further, the cooling passage 110 includes a nozzle portion 140 that includes a converging inlet nozzle 142, a diffuser throat 144, and a diverging outlet diffuser 146 arranged in serial order, with the fluid nozzle 138 of the VB outlet 128 oriented to provide the relatively high pressure fluid into the converging inlet nozzle 142. As will be appreciated, providing the high pressure fluid flow through the fluid nozzle 138 with the nozzle portion 140 located downstream, may urge a relatively low pressure fluid flow therethrough to increase the amount of airflow through the cooling passage 110.

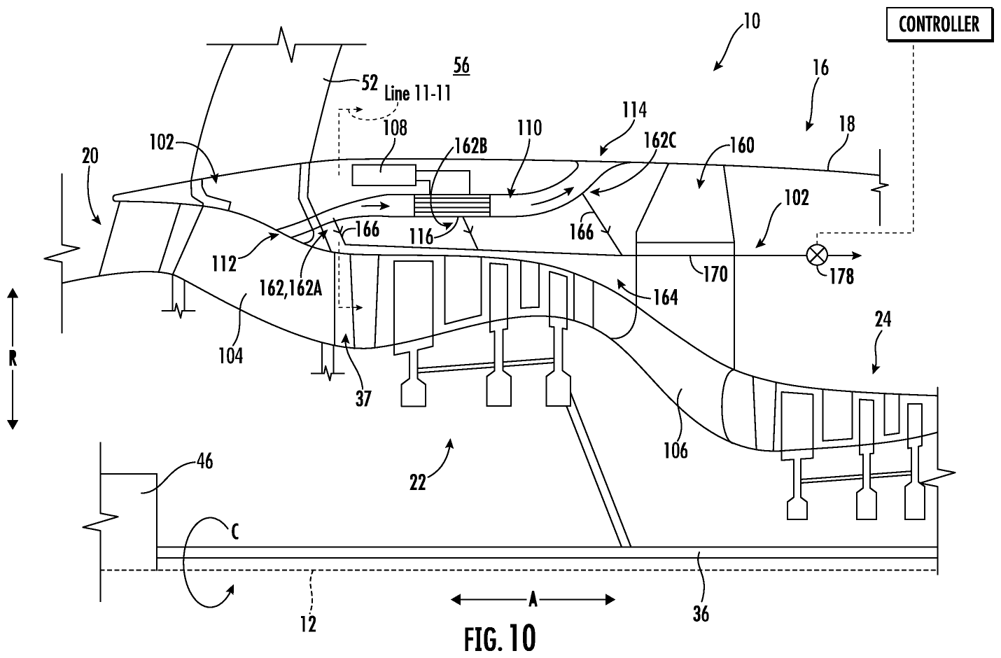

Moreover, it should be appreciated from the description herein and the Figures, that the variable bleed duct 124 having the VB inlet 126 and the VB outlet 128 may be a first variable bleed duct 124 of a plurality of variable bleed ducts 124 of the variable bleed assembly 122. For example, referring briefly to FIG. 9, a schematic, cross-sectional view is provided showing the variable bleed assembly 122 and the cooling passage 110 described above with reference to FIG. 7. As noted, the cooling passage 110 is an annular cooling passage. Further, the variable bleed assembly 122 includes the plurality of variable bleed ducts 124 spaced along the circumferential direction C of the gas turbine engine 10. Each of the variable bleed ducts 124 generally extends between the respective VB inlets 126 in airflow communication with the working gas flowpath 37 (FIG. 7) and respective VB outlets 128 in airflow communication with the cooling passage 110. Each of the plurality of variable bleed ducts 124 depicted in FIG. 9 may be configured in a similar manner as the exemplary variable bleed duct 124 described above with reference to FIGS. 7 and 8.

Referring now back to FIG. 7, it will be appreciated for the embodiment depicted, the gas turbine engine 10 further includes a controller 150 operably coupled to the variable bleed assembly 122, and one or more sensors 152. The one or more sensors 152 may be configured to sense data indicative of an operating condition of the gas turbine engine 10. For example, the one or more sensors 152 generally includes a bypass passage sensor 152A (e.g., configured to sense one or more of a pressure, a temperature, or an airflow rate of airflow through the bypass passage 56), an accessory system sensor 152B (e.g., configured to sense data indicative of a condition of the accessory system 108), a turbomachine sensor 152C (e.g., configured to sense data indicative of an operating condition of the turbomachine, such as a rotational speed sensor, a temperature sensor, a pressure sensor, etc.).

As noted, the exemplary controller 150 depicted in FIG. 7 is configured to receive the data sensed from the one or more sensors (sensors 152A, 152B, 152C) for the embodiment shown) and, e.g., may make control decisions for the variable bleed assembly 122 based on the received data.

In one or more exemplary embodiments, the controller 150 depicted in FIG. 7 may be a stand-alone controller 150 for the variable bleed assembly 122, or alternatively, may be integrated into one or more of a controller for the gas turbine engine 10 with which the variable bleed assembly 122 is integrated, a controller for an aircraft including the gas turbine engine 10 with which the variable bleed assembly 122 is integrated, etc.

Referring particularly to the operation of the controller 150, in at least certain embodiments, the controller 150 can include one or more computing device(s) 154. The computing device(s) 154 can include one or more processor(s) 154A and one or more memory device(s) 154B. The one or more processor(s) 154A can include any suitable processing device, such as a microprocessor, microcontroller, integrated circuit, logic device, and/or other suitable processing device. The one or more memory device(s) 154B can include one or more computer-readable media, including, but not limited to, non-transitory computer-readable media, RAM, ROM, hard drives, flash drives, and/or other memory devices.

The one or more memory device(s) 154B can store information accessible by the one or more processor(s) 154A, including computer-readable instructions 154C that can be executed by the one or more processor(s) 154A. The instructions 154C can be any set of instructions that when executed by the one or more processor(s) 154A, cause the one or more processor(s) 154A to perform operations. In some embodiments, the instructions 154C can be executed by the one or more processor(s) 154A to cause the one or more processor(s) 154A to perform operations, such as any of the operations and functions for which the controller 150 and/or the computing device(s) 154 are configured, the operations for operating a variable bleed assembly 122 (e.g., method 200), as described herein, and/or any other operations or functions of the one or more computing device(s) 154. The instructions 154C can be software written in any suitable programming language or can be implemented in hardware. Additionally, and/or alternatively, the instructions 154C can be executed in logically and/or virtually separate threads on the one or more processor(s) 154A. The one or more memory device(s) 154B can further store data 154D that can be accessed by the one or more processor(s) 154A. For example, the data 154D can include data indicative of power flows, data indicative of engine/aircraft operating conditions, and/or any other data and/or information described herein.

The computing device(s) 154 can also include a network interface 154E used to communicate, for example, with the other components of the variable bleed assembly 122, the gas turbine engine 10 incorporating variable bleed assembly 122, the aircraft incorporating the gas turbine engine 10, etc. For example, in the embodiment depicted, as noted above, the gas turbine engine 10 and/or variable bleed assembly 122 includes one or more sensors for sensing data indicative of one or more parameters of the gas turbine engine, the variable bleed assembly 122, the cooling passage 110, the accessory system(s) 108, or a combination thereof. The controller 150 of the variable bleed assembly 122 is operably coupled to the one or more sensors through, e.g., the network interface 154E, such that the controller 150 may receive data indicative of various operating parameters sensed by the one or more sensors during operation. Further, for the embodiment shown the controller 150 is operably coupled to, e.g., actuator 132. In such a manner, the controller 150 may be configured to vary an amount of airflow through the variable bleed assembly 122 and into the cooling passage 110 in response to, e.g., the data sensed by the one or more sensors. The network interface 154E can include any suitable components for interfacing with one or more network(s), including for example, transmitters, receivers, ports, controllers, antennas, and/or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

For the embodiment depicted, the controller 150 is configured to actuate the variable bleed valve 130 to increase or decrease the amount of airflow through the variable bleed duct 124. In certain exemplary aspects, the controller 150 may further be configured to receive data indicative of an operating condition of the gas turbine engine 10 (e.g., sensed data from the one or more sensors 152). In certain exemplary aspects, the controller 150 may actuate the variable bleed valve 130 to increase or decrease the amount of airflow through the variable bleed duct 124 in response to the data indicative of the operating condition.

For example, in response is to receiving data indicative of an operating condition whereby a relatively high amount of cooling may be needed, the controller 150 may be configured to actuate the variable bleed valve 130 to increase the amount of airflow through the variable bleed duct 124 (e.g., move the variable bleed valve 130 to a fully deployed position) to increase the amount of airflow through the cooling passage 110. By contrast, in response to receiving data indicative of an operating condition whereby a relatively low amount of cooling may be needed, the controller 150 may be configured to actuate the variable bleed valve 130 to decrease the amount of airflow through the variable bleed duct 124 (e.g., move the variable bleed valve 130 to a fully stowed position) to decrease the amount of airflow through the cooling passage 110.

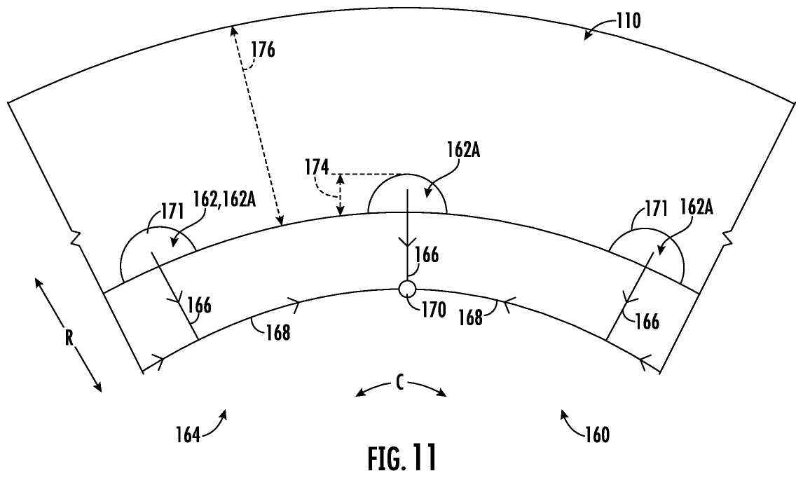

Referring now to FIG. 10, a gas turbine engine 10 in accordance with another exemplary aspect of the present disclosure is provided. The exemplary gas turbine engine 10 of FIG. 10 may be configured in a similar manner as exemplary gas turbine engine 10 described above with reference to FIGS. 1 and 2. The same or similar numbers may refer to the same or similar part.

For example, the exemplary gas turbine engine 10 depicted in FIG. 10 generally includes a turbomachine 16 having an outer casing 18 and defining an inlet 20 and (in part) a bypass passage 56 over the outer casing 18. The turbomachine 16 further defines an annular cooling passage, referred to herein simply as cooling passage 110, extending between a CP inlet 112 and a CP outlet 114. The cooling passage 110 may extend substantially continuously in a circumferential direction C of the gas turbine engine 10 (e.g., at least 300 degrees, such as at least 330 degrees, such as 360 degrees, with the exception of various structural components extending therethrough).

The CP inlet 112 is in airflow communication with a working gas flowpath 37, the bypass passage 56, or both. In particular, as with the embodiment of FIG. 2, the CP inlet 112 of the cooling passage 110 depicted in FIG. 10 is in airflow communication with the working gas flowpath 37. In such a manner, as with the embodiment above, the CP inlet 112 is configured to receive an airflow compressed by a fan 38 of the gas turbine engine 10 (see FIG. 1), prior to any additional stages of compression. Such may avoid loss of work when utilizing the airflow.

As described above, the gas turbine engine 10 includes an accessory system 108. As with the exemplary embodiments described above, the accessory system 108 may be an oil cooling system, a cooled cooling air system, an electric machine cooling system or a combination thereof.

Additionally, the turbomachine 16 includes a heat exchanger 116 positioned in thermal communication with the cooling passage 110 (e.g., in thermal communication with an airflow through the cooling passage 110 during operation of the gas turbine engine 10) at a location between the CP inlet 112 and the CP outlet 114. In particular, the heat exchanger 116 is positioned within, and extends across, the cooling passage 110. In such a manner, the heat exchanger 116 may define a portion of the cooling passage 110. In such a manner, the heat exchanger 116 may be configured to transfer heat from a fluid to the airflow through the cooling passage 110.

Further, for the embodiment shown, the heat exchanger 116 is in thermal communication with the accessory system 108 of the gas turbine engine 10 for transferring heat from the accessory system 108 to the airflow through the cooling passage 110. In such a manner the cooling passage 110 may provide cooling for the accessory system 108.

It will be appreciated that for the embodiment shown, although a single heat exchanger 116 and a single accessory system 108 are depicted, in other exemplary embodiments, other suitable configurations may be provided (see, e.g., FIG. 3).

Referring still to the exemplary embodiment of FIG. 10, the gas turbine engine 10 further includes a bleed cooling system 160. The bleed cooling system 160 defines a bleed cooling (BC) inlet 162 a duct assembly 164 in fluid communication with the BC inlet 162 for receiving airflow from the BC inlet 162. The BC inlet 162 is in airflow communication with the cooling passage 110 at a location between the CP inlet 112 and the CP outlet 114. In certain exemplary embodiments, the bleed cooling system 160 may be a clearance control system (see, e.g., clearance control system 84 described above with reference to FIG. 1), may be an under-cowl ventilation cooling system (see, e.g., under-cowl ventilation cooling system 82 described above with reference FIG. 1), or may be a combination thereof.

More specifically, for the embodiment depicted, the BC inlet 162 of the bleed cooling system 160 is a first BC inlet 162A and the bleed cooling system 160 further defines a second BC inlet 162B and a third BC inlet 162C.

For the embodiment depicted, the first BC inlet 162A of the bleed cooling system 160 is located downstream of the CP inlet 112 and upstream of the heat exchanger 116. In such a manner, the first BC inlet 162A may be configured to receive airflow from within the cooling passage 110 at a lower temperature (relative to downstream locations within the cooling passage 110), as the airflow has not yet exchanged heat with a fluid through the heat exchanger 116.

Further, for the embodiment depicted, the second BC inlet 162B of the bleed cooling system 160 is co-located with the heat exchanger 116. More specifically, the second BC inlet 162B is in airflow communication with the cooling passage 110 at a location aligned (along an axial direction A) with a location of the cooling passage 110 where the heat exchanger 116 is in thermal communication with the airflow through the cooling passage 110. Positioning the second BC inlet 162B at such a location may allow for the bleed cooling system 160 to receive airflow having desired aerodynamic properties, thermal properties, or combinations thereof.

Further, still, for the embodiment depicted, the third BC inlet 162C of the bleed cooling system 160 is located downstream of the heat exchanger 116 and upstream of the CP outlet 114. In such a manner, the third BC inlet 162C may be configured to receive airflow from within the cooling passage 110 at a higher temperature (relative to upstream locations within the cooling passage 110). However, providing airflow to the bleed cooling system 160 through the third BC inlet 162C may allow for a reduction in a back pressure within the cooling passage 110, e.g., increasing in effectiveness of the heat exchanger 116.

It will be appreciated, however, that although the exemplary bleed cooling system 160 depicted in FIG. 10 includes each of the first BC inlet 162A, the second BC inlet 162B, and the third BC inlet 162C, in other exemplary embodiments, the bleed cooling system 160 may only include the first BC inlet 162A, may only include the second BC inlet 162B, may only include the third BC inlet 162C, or may only include a combination of two of the first BC inlet 162A, second BC inlet 162B, and third BC inlet 162C.

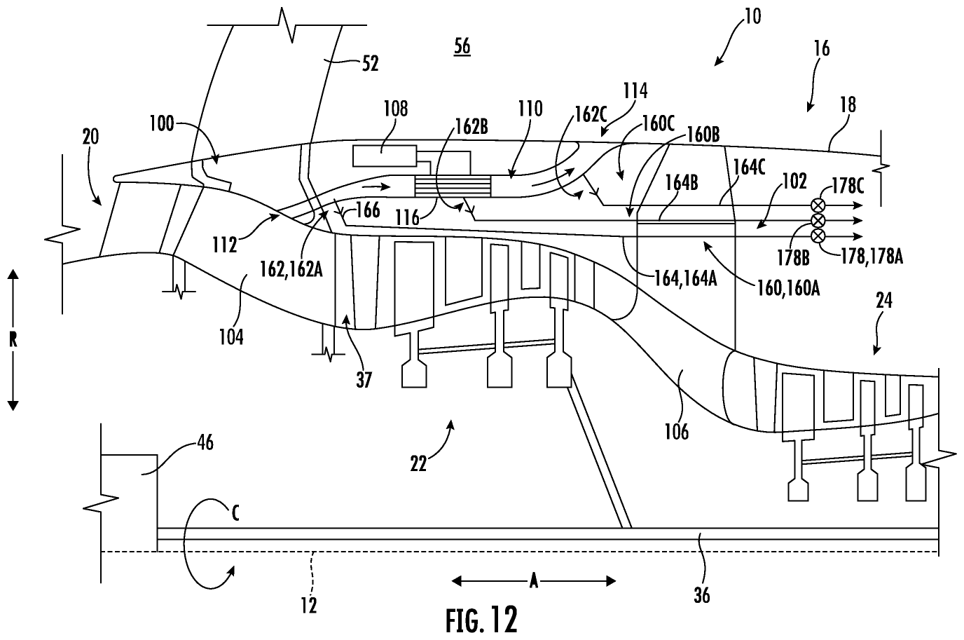

Moreover, it will be appreciated that in one or more of these exemplary embodiments, the BC inlet 162 noted at a particular location along the cooling passage 110 (e.g., first BC inlet 162A, second BC inlet 162B, and third BC inlet 162C) may include a plurality of BC inlets 162 spaced along the circumferential direction C to allow for extracting airflow through the cooling passage 110 along an annulus of the cooling passage 110 (as will be described in more detail below with reference to FIG. 11).

In particular, referring now to FIG. 11, providing a cross-sectional view of the cooling passage 110 of FIG. 10, along Line 11-11 in FIG. 10, it will be appreciated that the BC inlet 162 of the bleed cooling system 160, and more specifically the first BC inlet 162A of the bleed cooling system 160, is a one first BC inlet 162A of a plurality of first BC inlets 162A spaced along the circumferential direction C of the gas turbine engine 10. Each of the plurality of first BC inlets 162A is in airflow communication with the cooling passage 110 at the location between the CP inlet 112 and the CP outlet 114, and more specifically at the location downstream of the CP inlet 112 and upstream of the heat exchanger 116.

Notably, in the embodiment depicted, the duct assembly 164 of the bleed cooling system 160 includes a plurality of first ducts 166, one or more second ducts 168, and a third duct 170. More specifically, the plurality of first ducts 166 is a plurality of radial ducts extending from the respective plurality of first BC inlets 162A to receive airflow from the cooling passage 110 provided through the respective plurality of first BC inlets 162A. The one or more second ducts 168, in the embodiment depicted, are a plurality of circumferential ducts in airflow communication with the plurality of radial ducts for receiving the airflow from each of the plurality of radial ducts. Further, the third duct 170 is an axial duct receiving airflow from the plurality of circumferential ducts and transporting the received airflow to an aft location of the bleed cooling system 160 (e.g., the one or more under cowl areas for embodiments where the bleed cooling system 160 is an under-cowl ventilation cooling system, to a shroud cooling assembly for embodiments where the bleed cooling system 160 is a clearance control system, or the like).

As also depicted in FIG. 11, the bleed cooling system 160 may include one or more features for urging airflow into and through the plurality of BC inlets 162. In particular, for the embodiment depicted, the bleed cooling system 160 further includes a plurality of scoops 171, each scoop 171 located adjacent to a respective BC inlet 162 of the plurality of BC inlets 162 to direct airflow into and through the plurality of BC inlets 162. The scoops 171 define a height 174 along the radial direction R greater than or equal to 2% of a height 176 of the cooling passage 110 at the same axial location and less than or equal to 25% of the height 176 of the cooling passage 110 at the same axial location.

Although a plurality of discrete, fixed scoops 171 are depicted in FIG. 11, in other embodiments, other configurations may be provided to divert airflow into the BC inlets 162. For example, in other embodiments, the bleed cooling system 160 may alternatively include one or more scoops 171 extending along the circumferential direction C (similar to, e.g., the annular scoop 171 described above with reference to FIG. 4), one or more variable scoops 171 capable of being deployed and retracted, etc.

Briefly, referring back to FIG. 10, the bleed cooling system 160 depicted further includes a valve in airflow communication with the duct assembly 164 to modulate an amount of airflow through the duct assembly 164 of the bleed cooling system 160. In particular, for the embodiment depicted, the valve is a variable throughput valve 178, and the gas turbine engine 10 includes a controller 150 in operable communication with the variable throughput valve 178. The controller 150 in FIG. 10 may be configured in a similar manner as the exemplary controller 150 described above with reference to FIG. 7. In such a manner, the controller 150 may be configured to vary an amount of airflow through the bleed cooling system 160 in response to, e.g., an operating condition of the gas turbine engine 10, data sensed from one or more sensors of the gas turbine engine 10, etc.

It will be appreciated, however, that in other exemplary embodiments, the bleed cooling system 160 may additionally or alternatively include one or more similar valves elsewhere in the duct assembly 164, such as in airflow communication with, e.g., the plurality of first ducts 166, the one or more second ducts 168 (see FIG. 11), the third duct 170 at one or more alternative locations, or combinations thereof.

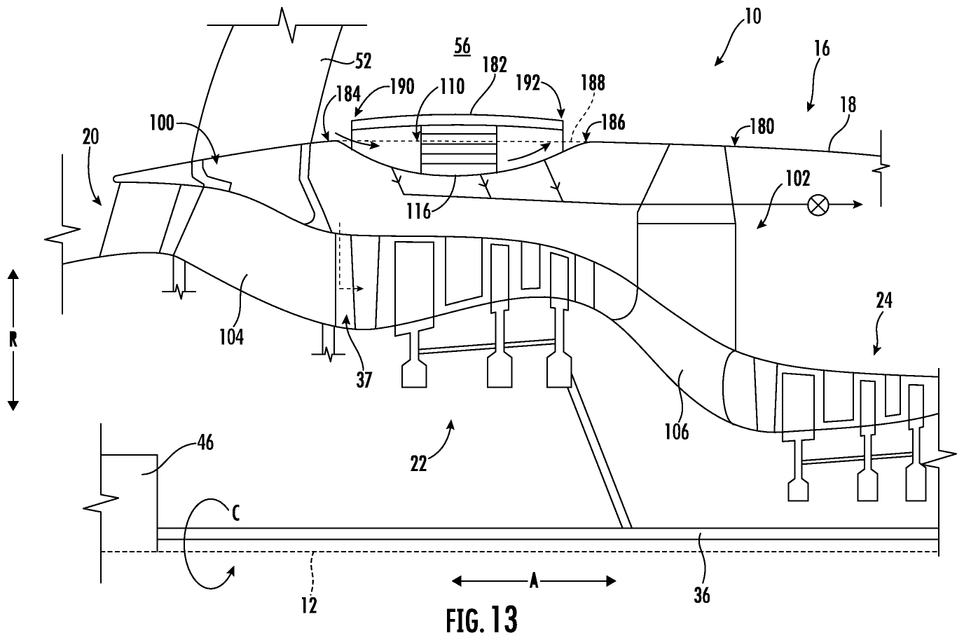

Further, in still other exemplary embodiments, the gas turbine engine 10 may have various other configurations. For example, referring now to FIG. 12, a gas turbine engine 10 having a cooling passage 110 in accordance with another exemplary embodiment of the present disclosure is provided. The exemplary gas turbine engine 10 and cooling passage 110 of FIG. 12 may be configured in a similar manner as the exemplary gas turbine engine 10 and cooling passage 110 described above with reference FIG. 10. The same or similar numbers may refer to the same similar part.

For example, the exemplary gas turbine engine 10 of FIG. 12 generally includes a bleed cooling system 160. However, for the embodiment depicted, the bleed cooling system 160 is a first bleed cooling system 160A and a BC inlet 162 of the first bleed cooling system 160A is a first BC inlet 162A.

The exemplary gas turbine engine 10 further includes a second bleed cooling system 160B defining a second BC inlet 162B in airflow communication with the cooling passage 110 at a second location between the CP inlet 112 and the CP outlet 114. The second BC inlet 162B is downstream of the first BC inlet 162A. Moreover, the exemplary gas turbine engine 10 depicted further includes a third bleed cooling system 160C defining a third BC inlet 162C in airflow communication with the cooling passage 110 at a third location between the CP inlet 112 in the CP outlet 114. The third BC inlet 162C is downstream of the second BC inlet 162B. Briefly, as with the BC inlet 162 (s) described above with reference to FIG. 10, the first BC inlet 162A, second BC inlet 162B, and third BC inlet 162C may each represent a plurality of first, second, or third BC inlets 162A, 162B, 162C spaced along the circumferential direction C of the gas turbine engine 10 (see FIG. 11).

For the embodiment depicted, the first BC inlet 162A is positioned between the CP inlet 112 and a heat exchanger 116 in thermal communication with the cooling passage 110. The second BC inlet 162B is co-located with the heat exchanger 116. The third BC inlet 162C is located downstream of the heat exchanger 116 and upstream of the CP outlet 114.

It will be appreciated, however, that in other exemplary embodiments, two or more of the BC inlets 162 may be positioned at similar locations (e.g., between the CP inlet 112 and heat exchanger 116, co-located with the heat exchanger 116, or between the heat exchanger 116 and the CP outlet 114).

Notably, each of the first bleed cooling system 160A, second bleed cooling system 160B, and third bleed cooling system 160C, for the embodiment depicted, includes a separate duct assembly 164 (i.e., first, second, and third duct assemblies 164A, 164B, 164C), and a valve 178A, 178B, 178C in airflow communication with the respective duct assemblies 164A, 164B, 164C to, e.g., modulate an amount of airflow therethrough.

Further, in still other exemplary embodiments of the present disclosure, the gas turbine engine 10 may have other configurations. For example, referring now to FIG. 13, a gas turbine engine 10 having a cooling passage 110 in accordance with another exemplary embodiment of the present disclosure is provided. The exemplary gas turbine engine 10 and cooling passage 110 of FIG. 13 may be configured in a similar manner as the exemplary gas turbine engine 10 and cooling passage 110 described above with reference FIG. 10. The same or similar numbers may refer to the same similar part.

For example, the exemplary gas turbine engine 10 of FIG. 13 generally includes a cooling passage 110 extending between a CP inlet 112 and the CP outlet 114. The gas turbine engine 10 further includes a bleed cooling system 160, which may be configured in a similar manner as one or more of the exemplary bleed cooling systems 160 described hereinabove, e.g., with reference to FIGS. 10 through 13.

The CP inlet 112 is in airflow communication with a working gas flowpath 37 of a turbomachine 16 of the gas turbine engine 10, a bypass passage 56 of the gas turbine engine 10, or both. In particular, for the exemplary embodiment of FIG. 13, the CP inlet 112 of the cooling passage 110 is in airflow communication with the bypass passage 56. Notably, as with the embodiments above, such a configuration may allow for the CP inlet 112 to receive airflow that has been pressurized by a fan 38 of a fan section 14 of the gas turbine engine 10 (see FIG. 1), without undergoing additional work/pressurization to avoid bleeding airflow that excess work applied thereto.

More specifically, the turbomachine 16 of the gas turbine engine 10 includes an outer casing 18, the outer casing 18 having an outer surface 180. The turbomachine 16 further includes a cowl 182 positioned outward of the outer casing 18 along a radial direction R of the gas turbine engine 10 and defining at least in part the cooling passage 110 with the outer casing 18. The cowl 182 extends from the CP inlet 112 to the CP outlet 114. The heat exchanger 116 is coupled to the cowl 182 for the embodiment shown.

As will be appreciated, the term “outer casing,” as used herein, broadly captures the outermost structure of the turbomachine 16 (absent the cowl 182), and may be formed of a plurality of components coupled together.

The outer casing 18 defines a forward stationary point 184 immediately forward of the CP inlet 112 and an aft stationary point 186 immediately aft of the CP outlet 114. The term “stationary point” refers to a position along the outer surface 180 of the outer casing 18, in an axial and radial plane (i.e., in a plane define by the axial direction A and the radial direction R, such as the plane of the view depicted in FIG. 13), where a tangent to the outer surface 180 of the outer casing 18, in the axial and radial plane, is parallel to a centerline 12 of the gas turbine engine 10. Further, the term “immediately forward” with respect to a position of the forward stationary point 184 relative to the CP inlet 112 refers to the first stationary point forward of the CP inlet 112. Similarly, the term “immediately aft” with respect to a position of the aft stationary point 186 relative to the CP outlet 114 refers to the first stationary point aft of the CP outlet 114.

Moreover, the outer casing 18 defines a reference line 188 extending from the forward stationary point 184 to the aft stationary point 186 in the axial and radial plane depicted. The cowl 182 of the turbomachine 16 defines at least in part the cooling passage 110 is positioned at least partially outward of the reference line 188 along the radial direction R. In particular, for the exemplary embodiment depicted, a forward end 190 of the cowl 182 is positioned entirely outward of the reference line 188 along the radial direction R and an aft end 192 of the cowl 182 is also positioned entirely outward of the reference line 188 along the radial direction R.

Moreover, the cooling passage 110 may be configured to receive less than 10% of the airflow through the bypass passage 56, such as less than 8% of the airflow through the bypass passage 56, and at least 0.05% of the airflow through the bypass passage 56. These percentages may be calculated during a cruise operating condition of the gas turbine engine 10, based on a mass flowrate of the airflow through the bypass passage 56.

Such a configuration may ensure a desired amount of airflow is provided through the cooling passage 110 for both cooling an accessory system of the gas turbine engine 10 (using the heat exchanger 116) and providing a cooling airflow for the bleed cooling system 160 of the gas turbine engine 10.

Further aspects are provided by the subject matter of the following clauses:

<Attorney to Add Once the Claims are Finalized; Clauses from Prior Application Copied Below.>

A gas turbine engine comprising: a fan assembly comprising a fan; a turbomachine drivingly coupled to the fan and comprising a compressor section, a combustion section, and a turbine section arranged in serial flow order and defining in part a working gas flowpath, the gas turbine engine defining a bypass passage over the turbomachine, the turbomachine defining an annular cooling passage extending between a CP inlet and a CP outlet, the CP inlet in airflow communication with the working gas flowpath and the CP outlet in airflow communication with the bypass passage; and a variable bleed assembly comprising a variable bleed duct extending between a VB inlet and a VB outlet, the VB inlet in airflow communication with the working gas flowpath at a location downstream of the CP inlet and the VB outlet in airflow communication with the annular cooling passage for urging an airflow through the cooling passage.

The gas turbine engine of any of the preceding clauses, wherein the compressor section comprises a compressor, wherein the CP inlet is in airflow communication with the working gas flowpath at a location upstream of the compressor, and wherein the VB inlet is in airflow communication with the working gas flowpath at a location downstream of the compressor.

The gas turbine engine of any of the preceding clauses, wherein the compressor is a low pressure compressor.

The gas turbine engine of any of the preceding clauses, wherein the compressor section further comprises a high pressure compressor, wherein the VB inlet is in airflow communication with the working gas flowpath at a location upstream of the high pressure compressor.

The gas turbine engine of any of the preceding clauses, wherein the variable bleed assembly comprises a variable bleed valve for varying an amount of airflow through the variable bleed duct.

The gas turbine engine of any of the preceding clauses, further comprising: a controller operably coupled to the variable bleed valve, wherein the controller is configured to actuate the variable bleed assembly to increase the amount of airflow through the variable bleed duct in response to an operating condition of the gas turbine engine to increase an amount of airflow through the annular cooling passage.

The gas turbine engine of any of the preceding clauses, wherein the VB outlet forms at least in part an ejector.

The gas turbine engine of any of the preceding clauses, wherein substantially all of an airflow through the variable bleed duct is provided through the VB outlet to the cooling passage.

The gas turbine engine of any of the preceding clauses, wherein the VB outlet is a first VB outlet, and wherein the variable bleed duct further comprises a second VB outlet, wherein the second VB outlet is in direct airflow communication with the bypass passage.

The gas turbine engine of any of the preceding clauses, wherein the turbomachine comprises a heat exchanger in thermal communication with the airflow through the cooling passage.

The gas turbine engine of any of the preceding clauses, wherein the VB outlet is in airflow communication with the cooling passage at a location downstream of the heat exchanger.

The gas turbine engine of any of the preceding clauses, wherein the gas turbine engine defines a circumferential direction, and wherein the heat exchanger is a first heat exchanger of a plurality of heat exchangers arranged along the circumferential direction within the annular cooling passage.

A method of operating a gas turbine engine comprising a fan assembly and a turbomachine drivingly coupled to a fan of the fan assembly, the method comprising: receiving data indicative of an operating condition of the gas turbine engine; and varying an amount of variable bleed airflow through a variable bleed duct provided to an annular cooling passage in response to the received data, the annular cooling passage extending between a CP inlet in airflow communication with a working gas flowpath of the turbomachine and a CP outlet in airflow communication with a bypass passage of the gas turbine engine.

The method of any of the preceding clauses, wherein the operating condition is a low fan power operating condition, and wherein varying the amount of variable bleed airflow through the variable bleed duct provided to the annular cooling passage comprises increasing the amount of variable bleed airflow through the variable bleed duct provided to the annular cooling passage.

The method of any of the preceding clauses, wherein the low fan power operating condition is a ground idle operating condition or a flight idle descent operating condition.

The method of any of the preceding clauses, wherein the operating condition is indicative of an ambient temperature.

The method of any of the preceding clauses, wherein the operating condition is indicative of the ambient temperature being greater than a threshold, and wherein varying the amount of variable bleed airflow through the variable bleed duct provided to the annular cooling passage comprises increasing the amount of variable bleed airflow through the variable bleed duct provided to the annular cooling passage.

The method of any of the preceding clauses, wherein the variable bleed assembly comprises a variable bleed valve for varying an amount of airflow through the variable bleed duct.

The method of any of the preceding clauses, wherein the turbomachine comprises a heat exchanger in thermal communication with an airflow through the cooling passage.

The method of any of the preceding clauses, wherein the VB outlet is in airflow communication with the cooling passage at a location downstream of the heat exchanger.

A gas turbine engine comprising: a fan assembly comprising a fan; a turbomachine drivingly coupled to the fan and comprising a compressor section, a combustion section, and a turbine section arranged in serial flow order and defining in part a working gas flowpath, the gas turbine engine defining a bypass passage over the turbomachine, the turbomachine defining an annular cooling passage extending between a CP inlet and a CP outlet, the CP inlet in airflow communication with the working gas flowpath, the bypass passage, or both; an accessory system; a heat exchanger positioned in thermal communication with the annular cooling passage at a location between the CP inlet and the CP outlet, the heat exchanger in thermal communication with the accessory system; and a bleed cooling system defining a BC inlet in airflow communication with the annular cooling passage at a location between the CP inlet and the CP outlet.

The gas turbine engine of any of the preceding clauses, wherein the accessory system is in thermal communication with the accessory system for cooling an oil cooling system, a cooled cooling air system, an electric machine cooling system, or a combination thereof.

The gas turbine engine of any of the preceding clauses, wherein the bleed cooling system is a clearance control system, an undercowl ventilation cooling system, or combination thereof.

The gas turbine engine of any of the preceding clauses, wherein the BC inlet of the bleed cooling system is located downstream of the CP inlet and upstream of the heat exchanger.

The gas turbine engine of any of the preceding clauses, wherein the BC inlet of the bleed cooling system is co-located with the heat exchanger.

The gas turbine engine of any of the preceding clauses, wherein the BC inlet of the bleed cooling system is located downstream of the heat exchanger and upstream of the CP outlet.

The gas turbine engine of any of the preceding clauses, wherein the bleed cooling system is a first bleed cooling system, wherein the BC inlet is a first BC inlet, and wherein the gas turbine engine further comprises: a second bleed cooling system defining a second BC inlet in airflow communication with the annular cooling passage at a second location between the CP inlet and the CP outlet, wherein the second BC inlet is downstream of the first BC inlet.

The gas turbine engine of any of the preceding clauses, wherein the BC inlet of the bleed cooling system is a first BC inlet of a plurality of BC inlets spaced along a circumferential direction of the gas turbine engine, wherein each of the plurality of BC inlets is in airflow communication with the annular cooling passage at the location between the CP inlet and the CP outlet.

The gas turbine engine of any of the preceding clauses, wherein the BC inlet of the bleed cooling system is a first BC inlet, wherein the bleed cooling system further defines a second BC inlet co-located with the heat exchanger or located downstream of the heat exchanger and upstream of the CP outlet.

The gas turbine engine of any of the preceding clauses, wherein the CP inlet in airflow communication with the bypass passage.

The gas turbine engine of any of the preceding clauses, wherein the turbomachine comprises a cowl and an outer casing defining an outer surface, wherein the cowl and the outer surface of the outer casing define at least in part the annular cooling passage.

The gas turbine engine of any of the preceding clauses, wherein the outer casing defines a forward stationary point immediately forward of the CP inlet, an aft stationary point immediately aft of the CP outlet, and a reference line extending from the forward stationary point to the aft stationary point, and wherein the cowl is located at least partially outward of the reference line.

The gas turbine engine of any of the preceding clauses, wherein the cowl defines a forward end and an aft end, wherein the forward end is positioned entirely outward of the reference line along a radial direction of the gas turbine engine, and wherein the aft end is also positioned entirely outward of the reference line along the radial direction.

The gas turbine engine of any of the preceding clauses, wherein the CP inlet is in airflow communication with the working gas flowpath.

The gas turbine engine of any of the preceding clauses, wherein the bleed cooling system further includes a duct assembly in airflow communication with the BC inlet for receiving an airflow from the BC inlet.

The gas turbine engine of any of the preceding clauses, wherein the bleed cooling system further includes a valve in airflow communication with the duct assembly to modulate an amount of airflow through the duct assembly of the bleed cooling system.

The gas turbine engine of any of the preceding clauses, further comprising: a controller, wherein the valve is a variable throughput valve, and wherein the controller is operably coupled to the variable throughput valve.

The gas turbine engine of any of the preceding clauses, wherein the BC inlet is one of a plurality of BC inlets spaced along a circumferential direction of the gas turbine engine, wherein the duct assembly comprises a plurality of radial ducts, wherein each radial duct is in airflow communication with a respective BC inlet of the plurality of BC inlets.

The gas turbine engine of any of the preceding clauses, wherein the turbomachine defines an under-cowl area, wherein the duct assembly further comprises an axial duct in airflow communication with the plurality of radial ducts, wherein the axial duct extends to the under-cowl area.

The gas turbine engine of any of the preceding clauses, wherein the bleed cooling system is a clearance control system having a shroud cooling assembly, wherein the duct assembly further comprises an axial duct in airflow communication with the plurality of radial ducts, wherein the axial duct extends to the shroud cooling assembly.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A gas turbine engine comprising:
a fan assembly comprising a fan;
a turbomachine drivingly coupled to the fan and comprising a compressor section, a combustion section, and a turbine section arranged in serial flow order and defining in part a working gas flowpath, the gas turbine engine defining a bypass passage over the turbomachine, the turbomachine defining an annular cooling passage (CP) extending between a CP inlet and a CP outlet, the CP inlet in airflow communication with the working gas flowpath, the bypass passage, or both;
an accessory system;
a heat exchanger positioned in thermal communication with the annular cooling passage at a location between the CP inlet and the CP outlet, the heat exchanger in thermal communication with the accessory system; and
a bleed cooling (BC) system defining a BC inlet in airflow communication with the annular cooling passage at a location between the CP inlet and the CP outlet.

2. The gas turbine engine of claim 1, wherein the accessory system is in thermal communication with the accessory system for cooling an oil cooling system, a cooled cooling air system, an electric machine cooling system, or a combination thereof.

3. The gas turbine engine of claim 1, wherein the bleed cooling system is a clearance control system, an undercowl ventilation cooling system, or combination thereof.

4. The gas turbine engine of claim 1, wherein the BC inlet of the bleed cooling system is located downstream of the CP inlet and upstream of the heat exchanger.

5. The gas turbine engine of claim 1, wherein the BC inlet of the bleed cooling system is co-located with the heat exchanger.

6. The gas turbine engine of claim 1, wherein the BC inlet of the bleed cooling system is located downstream of the heat exchanger and upstream of the CP outlet.

7. The gas turbine engine of claim 1, wherein the bleed cooling system is a first bleed cooling system, wherein the BC inlet is a first BC inlet, and wherein the gas turbine engine further comprises:
a second bleed cooling system defining a second BC inlet in airflow communication with the annular cooling passage at a second location between the CP inlet and the CP outlet, wherein the second BC inlet is downstream of the first BC inlet.

8. The gas turbine engine of claim 1, wherein the BC inlet of the bleed cooling system is a first BC inlet of a plurality of BC inlets spaced along a circumferential direction of the gas turbine engine, wherein each of the plurality of BC inlets is in airflow communication with the annular cooling passage at the location between the CP inlet and the CP outlet.

9. The gas turbine engine of claim 1, wherein the BC inlet of the bleed cooling system is a first BC inlet, wherein the bleed cooling system further defines a second BC inlet co-located with the heat exchanger or located downstream of the heat exchanger and upstream of the CP outlet.

10. The gas turbine engine of claim 1, wherein the CP inlet in airflow communication with the bypass passage.

11. The gas turbine engine of claim 10, wherein the turbomachine comprises a cowl and an outer casing defining an outer surface, wherein the cowl and the outer surface of the outer casing define at least in part the annular cooling passage.

12. The gas turbine engine of claim 11, wherein the outer casing defines a forward stationary point immediately forward of the CP inlet, an aft stationary point immediately aft of the CP outlet, and a reference line extending from the forward stationary point to the aft stationary point, and wherein the cowl is located at least partially outward of the reference line.

13. The gas turbine engine of claim 12, wherein the cowl defines a forward end and an aft end, wherein the forward end is positioned entirely outward of the reference line along a radial direction of the gas turbine engine, and wherein the aft end is also positioned entirely outward of the reference line along the radial direction.

14. The gas turbine engine of claim 1, wherein the CP inlet is in airflow communication with the working gas flowpath.

15. The gas turbine engine of claim 1, wherein the bleed cooling system further includes a duct assembly in airflow communication with the BC inlet for receiving an airflow from the BC inlet.

16. The gas turbine engine of claim 15, wherein the bleed cooling system further includes a valve in airflow communication with the duct assembly to modulate an amount of airflow through the duct assembly of the bleed cooling system.

17. The gas turbine engine of claim 16, further comprising:
a controller, wherein the valve is a variable throughput valve, and wherein the controller is operably coupled to the variable throughput valve.

18. The gas turbine engine of claim 15, wherein the BC inlet is one of a plurality of BC inlets spaced along a circumferential direction of the gas turbine engine, wherein the duct assembly comprises a plurality of radial ducts, wherein each radial duct is in airflow communication with a respective BC inlet of the plurality of BC inlets.

19. The gas turbine engine of claim 18, wherein the turbomachine defines an under-cowl area, wherein the duct assembly further comprises an axial duct in airflow communication with the plurality of radial ducts, wherein the axial duct extends to the under-cowl area.

20. The gas turbine engine of claim 18, wherein the bleed cooling system is a clearance control system having a shroud cooling assembly, wherein the duct assembly further comprises an axial duct in airflow communication with the plurality of radial ducts, wherein the axial duct extends to the shroud cooling assembly.
